(19) United States
(12) Patent Application Publication
(10) Pub. No.: US 2008/0217912 A1
(43) Pub. Date: Sep. 11, 2008

(54) Coupling

(75) Inventor: Jerome Chaupin, Echirolles (FR)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 11/994,883

(22) PCT Filed: Jun. 1, 2006
(86) PCT No.: PCT/EP06/05217

§ 371 Date: Jan. 7, 2008

(30) Foreign Application Priority Data
Jul. 23, 2005 (DE) 102005034567.0

(51) Int. Cl. F16L 21/03

(52) U.S. Cl. 285/231

(57) ABSTRACT

A coupling comprises a socket member (1) and a sealing ring (10) that is fixable in a receiving space (4) adapted to receive an insert member (13) insertable into the socket member (1) in an insertion direction. In assembled arrangement, the sealing ring (10) bears against mutually opposite contact surfaces (9, 11), said contact surfaces (9, 11) lying partially outside a plane oriented at right angles to the insertion direction. The insert member (13) thereby comes into contact first with front portions and then gradually with rear portions of the sealing ring (10), such that appreciably lower insertion forces are required because of the porportionately low static friction forces.

### BACKGROUND OF THE INVENTION

1. Field of the Invention

The present invention concerns a coupling.

2. Description of the Related Art

One known coupling is disclosed in U.S. Pat. No. 3,831,954. In this device, mutually parallel contact surfaces for a sealing ring extend in the form of disk plates positioned obliquely to the insertion direction in order to reduce the insertion forces needed to insert an insert member into the socket member—at the beginning of the insertion process, at any rate—compared to an arrangement in which the contact surfaces are at right angles to the insertion direction.

Also known from EP 0 616 164 A1 is a sealing ring configured with a cylindrical outer surface and a fully circumferentially extending, dome-like elevation formed on the outside of said outer surface. The sealing ring is arranged in a socket member and oriented at right angles to the insertion direction of an insert member.

Also known from U.S. Pat. No. 5,137,308 is a retaining ring that is matable to a socket member and serves to fix a sealing ring.

### SUMMARY OF THE INVENTION

The present invention provides a coupling that is distinguished by comparatively low insertion forces during the insertion particularly of a large insert member into the receiving space.

By virtue of the inventively arranged pairs of front portions and rear portions, the sealing ring is so arranged as to undulate between two planes oriented orthogonally to the insertion direction. The insert member, on being inserted into the receiving space, comes into contact first with the two front portions, located to the fore in the insertion direction, then, as the insertion process continues, gradually with central portions and finally with the two rear portions, located to the rear in the insertion direction, of the sealing ring, such that compared to full-area contact with a planar sealing ring at the very beginning of the insertion process, appreciably lower insertion forces are required because of the proportionately lower static friction forces. This is a considerable advantage particularly in the case of relatively large-diameter couplings.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a sectional view of an exemplary embodiment of an inventive coupling with an insert member just prior to insertion in a receiving space; and

FIG. 2 is a perspective view of a socket member and a retaining ring of the coupling according to the invention as illustrated in FIG. 1.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

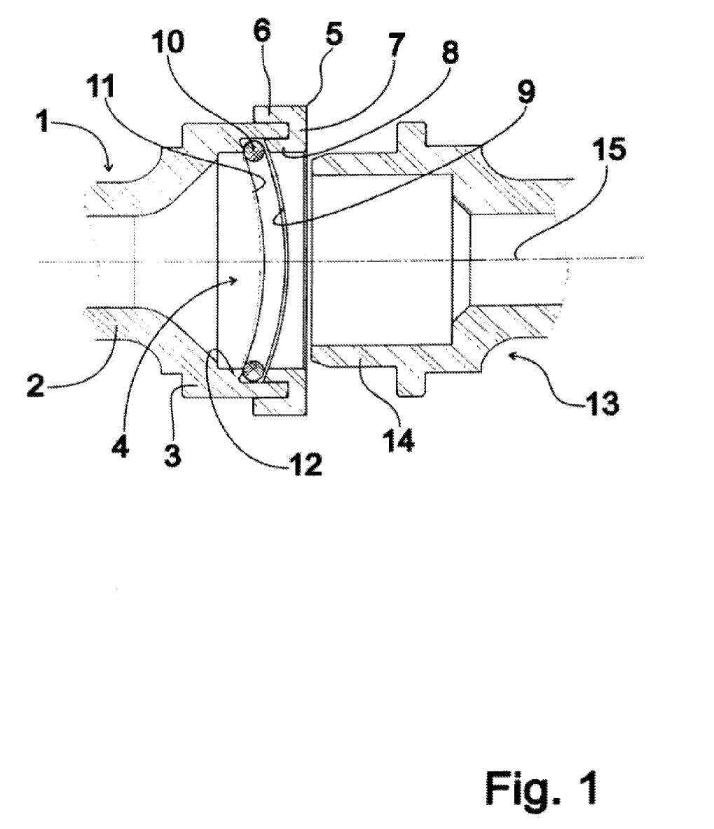

FIG. 1 is a sectional view of an exemplary embodiment of a coupling according to the invention. The exemplary embodiment according to FIG. 1 comprises a socket member 1, serving for example as an end piece for a fluid-conveying system not shown in FIG. 1. The socket member 1 has a substantially cylindrical base portion 2, which for example is connectable to the fluid-conveying system, and a substantially cylindrical head portion 3 having a greater circumference than the base portion 2. The head portion 3 encloses a cylindrical receiving space 4.

In the exemplary embodiment shown, the coupling is equipped with a retaining ring 5 that can be mated to the side of head portion 3 facing away from base portion 2. The retaining ring 5 comprises an outer edge collar 6 that embraces the outer wall of head portion 3, an end-face collar 7 that bears against the end face of head portion 3 facing away from base member 2, and an inner edge collar 8 that projects into the receiving space 4.

Bearing against a first contact surface 9 formed on retaining ring 5 is an annular closed sealing ring 10, which is made of an elastic material and additionally bears by its side facing away from first contact surface 9 against a second contact surface 11 configured on a support step 12 that is present in the receiving space 4. The contact surfaces 9, 11 are arranged at a mutual spacing that remains constant over the circumference.

Finally, depicted in FIG. 1 is a known per se insert member 13 of the inventive coupling, which can be inserted by an insertion portion 14 into the opposite side of head portion 3 from base portion 2 and into the receiving space 4 in an insertion direction coincident with the longitudinal axis 15 of the coupling. The purpose of receiving ring 10 is to create a tight connection between the socket member 1 and the insert member 13.

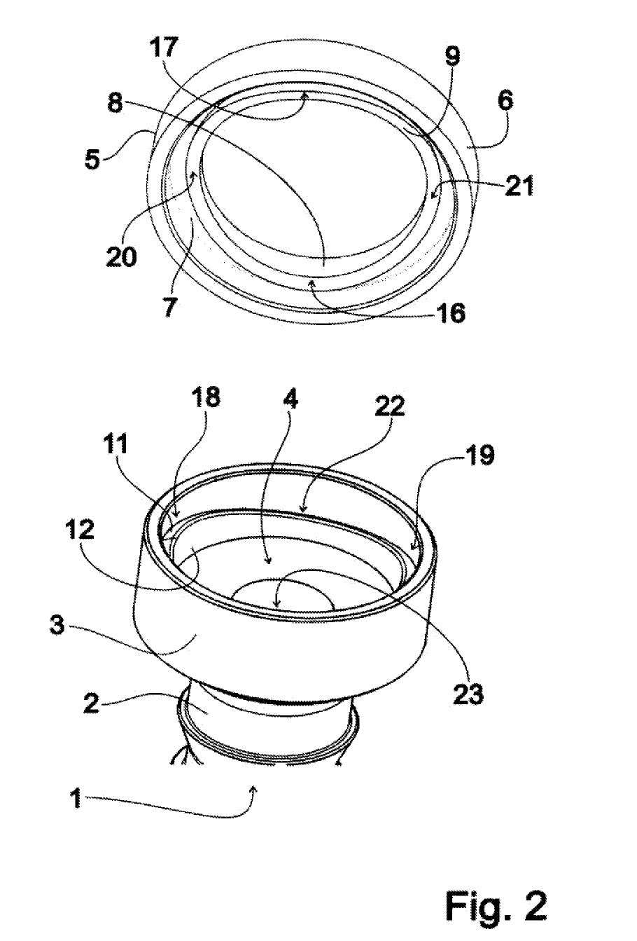

FIG. 2 is a perspective view of the socket member 1 in the region of the head portion 3 and the retaining ring 5 of the inventive coupling according to FIG. 1. It can be seen from FIG. 2 that the contact surfaces 9, 11 lie at least partially outside a plane oriented at right angles to the insertion direction, which is parallel to the longitudinal axis 15, and that in the exemplary embodiment shown, the contact surfaces 9, 11 are each configured with two mutually diametrically opposite front portions 16, 17, 18, 19 located to the fore in the viewing direction of FIG. 2 and with two mutually diametrically opposite rear portions 20, 21, 22, 23 arranged between the front portions 16, 17, 18, 19 and located to the rear in the viewing direction of FIG. 2. In the intended arrangement, the front portions 18, 19 of contact surface 11 configured on head portion 3 are disposed opposite the rear portions 20, 21 of contact surface 9 configured on the retaining ring 5, while the rear portions 22, 23 of contact surface 11 configured on head portion 3 are therefore disposed opposite the front portions 16, 17 of contact surface 9 configured on retaining ring 5.

In this way, the insert member 13, on being inserted into the receiving space 4, first comes into contact with the front faces of sealing ring 10, which are located between the front portions 18, 19 of contact surface 11 configured on head portion 3 and the rear portions 20, 21 of contact surface 9 configured on retaining ring 5, before, as the insertion process continues with a relatively low insertion force, contact is finally made with the rear faces of sealing ring 10, which are located between the other front portions 16, 17 and rear portions 22, 23 of contact surfaces 9, 11 and the sealing effect comes about.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-5. (canceled)

6. A coupling, comprising:
a socket member including a receiving space having a pair of mutually opposite contact surfaces;
an insert member insertable into said socket member along an insertion direction; and
a sealing ring received within said receiving space and bearing against said contact surfaces, said contact surfaces including circumferentially extending sections that are at least partially disposed outside of a first plane that is oriented perpendicular to the insertion direction and that intersects said contact surfaces, each of said contact surfaces including two mutually opposite front portions and two mutually opposite rear portions circumferentially between said front portions, said sealing ring undulating between a pair of two second planes that are oriented perpendicular to said insertion direction.

7. The coupling of claim 6, wherein said front portions are disposed diametrically opposite each other and said rear portions are disposed diametrically opposite each other, said front portions disposed on one side of the first plane and said rear portions disposed on another side of the first plane.

8. The coupling of claim 6, further comprising a retaining ring mated to said socket member, said mating ring including one of said contact surfaces.

9. The coupling of claim 6, wherein one of said contact surfaces of said socket member is on a support step in said receiving space.

10. The coupling of claim 6, wherein said contact surfaces are arranged at a mutual spacing that is constant over circumferences thereof.
